(19) United States
(12) Patent Application Publication
(10) Pub. No.: US 2014/0162613 A1
(43) Pub. Date: Jun. 12, 2014

(54) Audio Sample

(71) Applicants: Rajan Lukose, Oakland, CA (US); Shyam Sundar Rajaram, San Francisco, CA (US); Martin B. Scholz, San Francisco, CA (US)

(72) Inventors: Rajan Lukose, Oakland, CA (US); Shyam Sundar Rajaram, San Francisco, CA (US); Martin B. Scholz, San Francisco, CA (US)

(21) Appl. No.: 14/131,493

(22) PCT Filed: Jul. 12, 2011
(86) PCT No.: PCT/US2011/043636

§ 371 Date: Jan. 8, 2014

(51) Int. Cl. H04W 4/18

(52) U.S. Cl. CPC H04W 4/18
USPC 455/414.1

(57) ABSTRACT

In the present disclosure, methods and apparatuses are disclosed that enable a device to determine whether a contact is in a shared environment based on an audio sample of a voice call. More specifically, an audio sample of a voice call is generated. A controller then determines whether a contact is in an environment of the mobile device based on the audio sample.

### BACKGROUND

Conventional bookmarking systems enable a user to bookmark items of interest for future use. These bookmarking systems are typically contained and utilized within a web browser. The utility of the system relies on a user proactively accessing the bookmark to deliver the bookmarked content.

### BRIEF DESCRIPTION OF THE DRAWINGS

FIG. 1 illustrates an example apparatus in accordance with the present disclosure;

FIG. 2 illustrates an example apparatus in accordance with the present disclosure;

FIG. 3 illustrates a example system in accordance with the present disclosure;

FIG. 4 illustrates examples of delivered bookmarks in accordance with the present disclosure; and

FIGS. 5-8 illustrate example flow diagrams in accordance with the present disclosure.

### DETAILED DESCRIPTION

Generally, bookmarking systems enable a user to flag content for consumption at a later time. The flagged or bookmarked content is delivered in response to a user accessing or triggering the bookmark. Bookmarks may be utilized in a variety of manners and for a variety of purposes. In one example, a user may bookmark a webpage in a web browser as a means of quickly retrieving the content at a later time. The user may have bookmarked the web page in order to show another individual the web page when they become available. The bookmarking system, however, provides no manner of alerting the user upon the other individual becoming available.

In the present disclosure, methods, apparatus, systems, and associated programming instructions are disclosed that enable a computing device, such as a mobile device, to deliver a bookmark in response to detection of an individual in a shared environment. The mobile device may discretely generate audio samples of a voice received, for example, during a call. The audio samples may be associated with a contact. When the contact is determined to be within a shared environment with the mobile phone, the mobile phone may trigger a bookmark. In this manner, delivery of bookmarks may be automated.

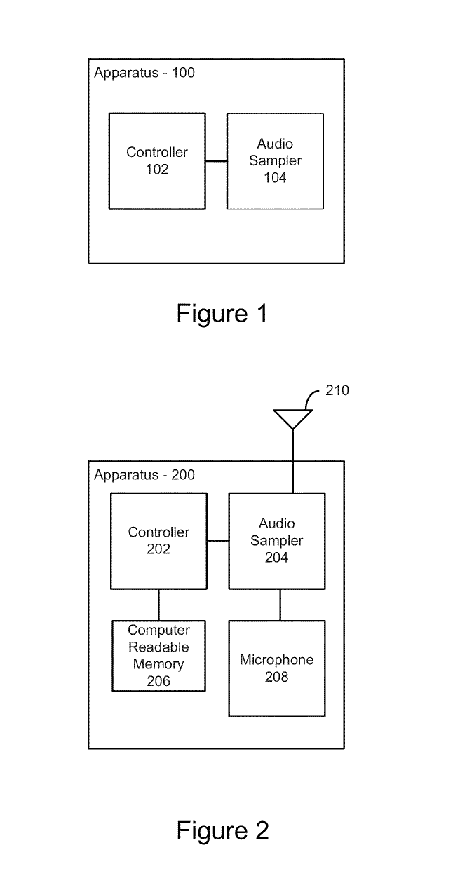

Referring to FIG. 1, an example apparatus is illustrated in accordance with the present disclosure. The apparatus 100 includes a controller 102 and an audio sampler 104, coupled together as illustrated. The apparatus may be a computing device including, but not limited to, smart phones, cell phones, tablets, notebook computers, netbook computers, voice over internet (VOIP) phones, or any other computing device capable of transmitting and receiving calls. As used herein, a voice call is defined as a voice transmission between two individuals utilizing an apparatus such as apparatus 100. A voice call may include video or other signals without deviating from the scope of the disclosure.

Audio sampler 104 is a component capable of generating an audio sample of a voice call and/or environmental noise. The audio sampler 104 may be an integrated circuit such as an application specific integrated circuit (ASIC), or may be embodied in computer readable instructions executable by a processor. The audio sampler 104 may include various components such as microphones, samplers, or other elements, or may be operatively coupled to such elements. The audio sampler 104 is to sample an incoming transmission received via a network, wherein the incoming transmission includes modulated signals corresponding to a voice of a contact. The audio sampler is also to sample noise in an environment to generate audio samples of environmental noise.

The controller 102 is a component coupled to the audio sampler 104. The controller 102 is to compare an audio sample of the voice call generated by the audio sampler 104 with environmental noise to determine whether a contact associated with the voice call is located in the environment. The controller 102 may be an integrated circuit, an ASIC, or may be embodied in computer readable instructions executable by a processor. In various embodiments, the audio sampler 104 and the controller 102 may be integrated into a single component.

In one example, the apparatus 100 is a mobile device, such as a mobile phone. The mobile phone may include a contact list (e.g. an address book) of individuals known to an owner or user of the mobile device. During a voice call, the apparatus 100, via the controller 102 and the audio sampler 104, may generate an audio sample of the voice call. The controller 102 may associate the sample of the voice call with the contact, and store the sample in memory. In a discrete manner, the apparatus 100 may generate samples of all users within the contact list. An audio sample may include recorded audio or data generated based on the recorded audio, using for example, a speaker recognition algorithm.

The apparatus 100, via the controller 102 and the audio sampler 104, may also generate audio samples of an environment of the apparatus 100 by sampling background noise. The controller 102 may compare the sample of the background noise against the various audio samples of voice calls, previously generated, to determine whether any of the individuals in the contact list are present in the environment (e.g, a shared environment).

The apparatus 100, via controller 102, may generate a bookmark. A bookmark, as used herein, includes any media content, notes, alerts, or other material flagged, or bookmarked by an individual. The bookmark may be utilized as an alert, a reminder, or to provision content to an individual at a later time. Bookmarks may include a message generated by a user of the apparatus 100, media content, or messages/content generated by others. The controller 102 may generate a bookmark and associate the bookmark with a contact having an audio sample, and trigger the bookmark in response to a determination that the contact is located in the environment. In this manner, the apparatus 100 may provision the bookmark based upon availability and/or proximity of an individual.

In various examples, the controller 102 is to determine whether the contact is located in the environment based, in part, on a speaker recognition technique. Speaker recognition techniques are defined as any techniques suitable for use to identify and/or verify an individual based on sound. Such techniques enable an apparatus to determine which one of a group of known voices best matches the input voice sample, wherein the input voice sample is an audio sample of background noise received from an environment and the group of known voices are the audio samples generated by the controller 102 and the audio sampler 104 during voice calls. Such speaker recognition techniques include Gaussian mixture speaker models, frequency estimation, hidden Markov models, pattern matching algorithms, neural networks, matrix representation, Vector Quantization and decision trees, among others. The speaker recognition techniques may be text dependent or text independent.

Referring to FIG. 2, another example is illustrated in accordance with the present disclosure. Apparatus 200 may include similar components to that of FIG. 1, such as controller 202 and audio sampler 204. In addition, apparatus 200 includes a computer readable memory 206, microphone 208, and an antenna 210. Computer readable medium 206 may include programming instructions, which if executed by a processor, may enable apparatus 200 to perform various operations as described herein. Apparatus 200 similar to apparatus 100 may be a computing device such as a mobile device configured to receive and transmit voice calls.

In the example, computer readable medium 206 may include a contact list of known individuals. The contact list may include information associated with a contact, such as phone numbers, addresses, notes, email addresses, birthdays, and/or other information. Based on the contact list stored in computer readable medium 206, controller 202 and and/o sampler 204 may generate audio samples of each contact via a voice call to or from apparatus 200. The audio samples may be automated such that a user of apparatus 200 receives no indication that audio samples are being generated. The audio samples may be taken at various predefined positions within the call. For example, audio sampler 204 may sample an outgoing call such that an audio sample is generated based on at least a first word spoken upon a call connection (e.g., “hello”). Such an audio sample may be a text dependent sample. In another example, the audio sampler may simply sample the incoming transmission via antenna 210. The sample may include various words unpredictable to audio sampler 104 and therefore may be text independent. In various examples, by sampling the incoming signal, the controller and audio sampler are able to differentiate users and correctly associate an audio sample with the contact.

The controller 202 is also to generate and associate bookmarks with a contact in the contact list. The bookmarks may include media content, messages, alerts, audio content, or other data conveyable to a user of the apparatus 200. In this manner, an audio sample and a bookmark may be associated with a contact and stored within computer readable memory 206. The bookmark intended to be accessed or delivered based upon a determination that the contact is within a shared environment with the apparatus 200.

In addition to generating audio samples of voice calls, the audio sampler 204 may be coupled to microphone 208. Microphone 208 may be a microphone intended for use to receive an owner's or user's voice transmission to a contact, or alternatively, may be an independent microphone disposed and intended for use to sample background noise of an environment. In either case, the audio sampler 204 may sample noise in an environment. The audio sampler 204 may sample background noise periodically, or alternatively may be triggered to sample background noise based upon an indication that noise above an ambient level is detected.

The controller 202, based upon an indication of an audio sample of the background, may begin a speaker recognition technique to determine whether a contact having an associated bookmark is present within a shared environment. Upon an indication that a speaker is present, the apparatus 200 may deliver the bookmark. The determination that the contact is present may be based upon a speaker recognition technique determining that a contact is more likely than not within the shared environment. The determination may be based on a percentage or likelihood.

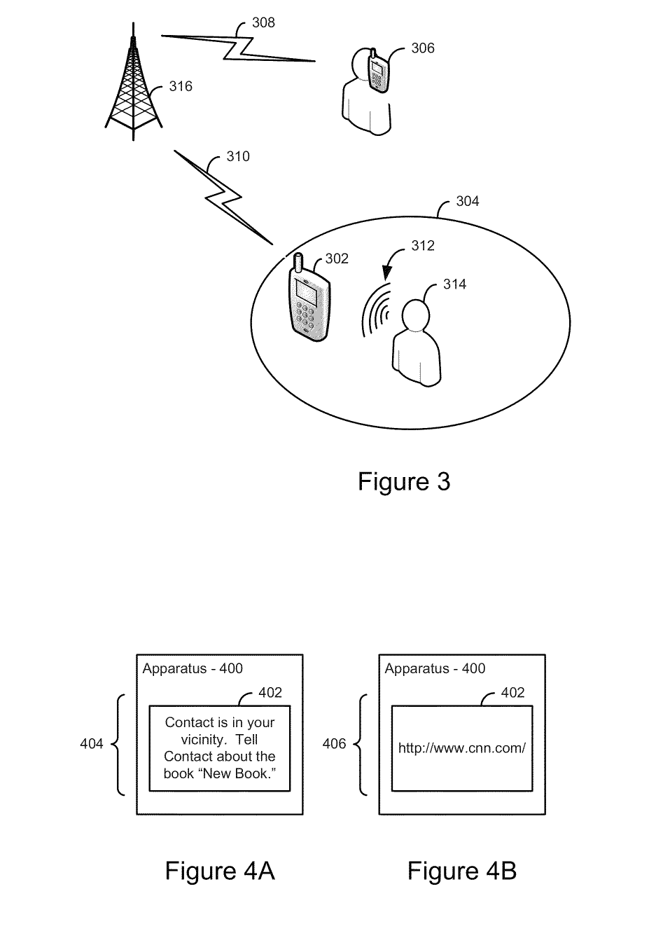

Referring to FIG. 3, a system is illustrated in accordance with the present disclosure. FIG. 3 includes an apparatus 302, for example an apparatus as described with reference to FIG. 1 or 2, within an environment 304, contacts 306 and 314, wireless transmissions 310 and 308, and network access point 316.

In FIG. 3, contact 306 is in a voice call with apparatus 302 as illustrated by wireless transmissions 310 and 308. Contact 306 includes an entry in a contact list stored within apparatus 302, and therefore, identifies that contact 306 is a known individual to an owner/user of apparatus 302. As contact 306 speaks, their voice is sampled, modulated, and transmitted via communication links 308, 310 and network access point 318 to apparatus 302. Apparatus 302 may then demodulate the received signals, sample the demodulated transmissions, and store an audio sample of the voice call. In this manner, apparatus 302 may generate audio samples for each contact within a contact list.

The apparatus 302 may also generate a bookmark associated with a contact having a corresponding audio sample stored within memory. In the illustration, contact 314 is a contact having an entry within the contact list and a previously stored audio sample. The apparatus 302 may sample background noise, for example the voice of contact 314 within the environment 304 and determine that the contact 314 is within a shared environment. A shared environment is defined as an environment in which the contact and the apparatus are within a vocally identifiable distance of each other. That is, an environment of the apparatus may be defined by the ability of the apparatus to sample and distinguish voices within the background.

The apparatus 302 may sample background noise and may generate an audio sample of voice 312. Based on the audio sample of voice 312, the apparatus 302 may utilize a voice recognition technique to identify contact 314 from various other contacts having stored audio samples. In response to the determination, the apparatus 302 may deliver a bookmark.

A bookmark may include media content, alerts, or other data conveyable to a user of apparatus and a contact. As illustrated in FIGS. 4A and 4B, two example bookmarks are illustrated. Apparatus 400 is utilized to display or deliver bookmarks 404 and 406, via a display 402. While FIGS. 4A and 4B utilize a display to deliver bookmarks, other components may be utilized to deliver bookmarks of different types. For example, a speaker may be utilized to deliver an audio bookmark.

Referring to FIG. 4A, an apparatus 400, which is an apparatus described with reference to FIGS. 1-3, is illustrated delivering a bookmark 404 via a display 402. The bookmark may be a message intended to remind a user of information intended to be delivered to a contact upon a determination that they are located within a shared environment. In the Figure, the bookmark states, “Contact is in your vicinity. Tell contact about book “New Book.” Consequently, the bookmark is a message generated by a user that enables the user to convey information or data to an intended contact.

In FIG. 4B, apparatus 400 is illustrated delivering a bookmark 406 to a user via display 402. In the illustration, the bookmark 406 includes a hyperlink to a web address on the world wide web associated with the Internet. The bookmark may be actionable, such that a user may click on the hyperlink and be delivered to an associated webpage. Alternatively, the bookmark 406 may merely be a text message upon which a user is reminded that they wished to share a webpage with a contact determined to be within an environment. Bookmarks may also include audio signals, tactile alerts (e.g. vibration), or other forms of data communication.

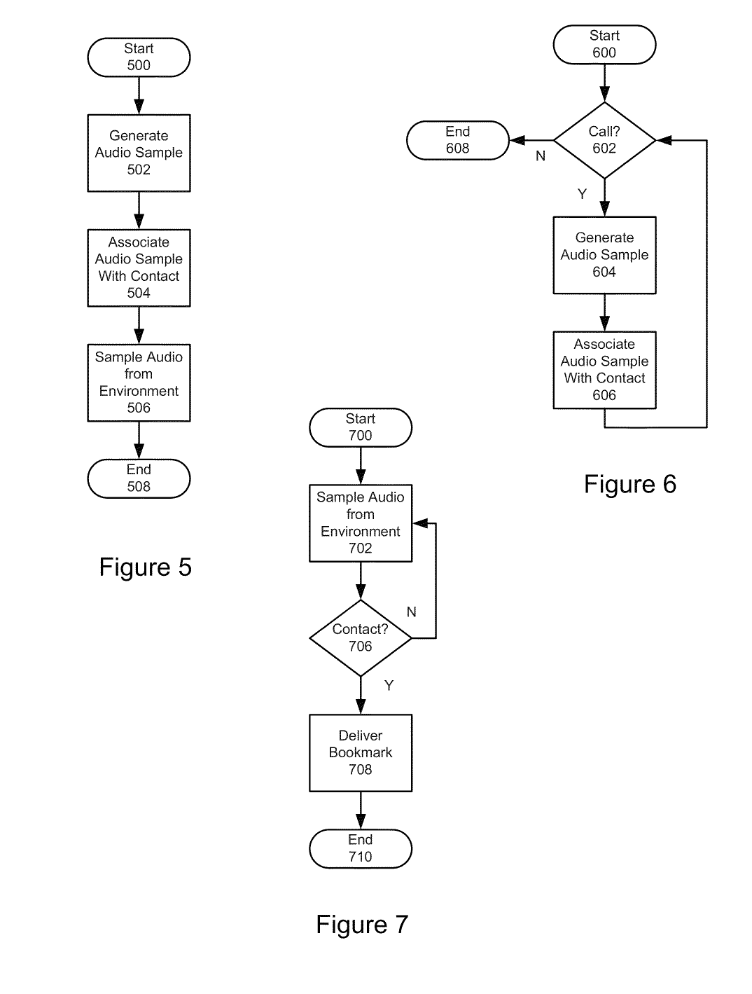

Referring to FIGS. 5-8, flow diagrams are illustrated in accordance with various examples of the present disclosure. The flow diagrams illustrate various elements or instructions that may be executed by an apparatus, such as an apparatus described with reference to FIGS. 1-3.

Referring to FIG. 5, the flow diagram begins at 500 and continues to 502 where a mobile device may generate an audio sample of a voice received via a call. The mobile device may be an apparatus as described with reference to FIGS. 1-3. The audio sample may be text dependent or text independent and may last for a predetermined portion of time. Alternatively, a length of the audio sample may be determined based upon other characteristics, for example, a quality of the audio signal received.

With an audio sample generated, the flow diagram may continue to 504 where the mobile device may associate the audio sample with a contact participating in the call, wherein the contact is included in a contact list of the mobile device. In other words, the mobile device may have stored contact information in a manner presentable to a user as a contact list. The mobile device may systematically generate audio samples of each and every contact within the list and store the associated audio sample with the contact.

After the associating, the mobile device may sample audio from an environment to determine whether the contact is in the environment at 506. The determination may be based, in part, on the audio samples of the voice. The environment may comprise an area in which the mobile device is capable of distinguishing voices from ambient noise. In this manner, the mobile device is capable of determining whether a contact of the user is within a shared environment and capable of interfacing with a user.

The method may then end at 508. In various embodiments, ending may comprise the continued generation of audio samples from voice calls and/or continued sampling of noise from an environment to determine whether a contact is in a shared environment.

Referring to FIG. 6, a flow diagram associated with generating an audio sample is illustrated. The method may begin at 600 and continue to 602 where a mobile device may determine whether a call has been received or instigated. If a call has been received or instigated, the method may continue to 604 where the mobile device may generate an audio sample. Generating an audio sample may include sampling a predefined portion of the call, or alternatively, sampling the incoming transmission, wherein the incoming transmission is defined as the signal corresponding to the contacts voice.

After generating the audio sample at 604, the mobile device may associate the audio sample with the contact at 606. The associating may include storing the audio sample in memory associated with the identity of the contact. The presence of an associated audio sample may be indicated in the contact list, thereby informing a user of the mobile device that a bookmark may be generated, such that when the contact is within a shared environment, the bookmark will be delivered. After completing the associating of the audio sample with the contact, the method may continue to monitor for call at 602.

In various examples, continued monitoring of a call at 602 may result in the generating of an audio sample of another voice received via another call. Based on the receipt of another voice and the generating of another audio sample, the mobile device may associate the audio sample of the another voice with another contact participating in the call, wherein the another contact is also included in the contact list of the mobile device.

If at 602, no call is received or instigated by the mobile device, the method may end at 608, In various embodiments, ending may comprise the continued monitoring for calls at 602.

Referring to FIG. 7, a flow diagram illustrated various elements associated with sampling environmental noise are illustrated. The method may begin at 700 and continue to 702 where a mobile device may sample audio from an environment to determine whether a contact is in the environment. Sampling of the audio from the environment may include the use of a microphone, various filters to filter out ambient noise, and/or digital signal processing techniques capable of signal recovery and repair.

With a sample of the background noise, various voices may be isolated and compared against audio samples of the contacts. At 706, the device may determine whether a contact is in a shared environment based on the audio sample and a speaker recognition technique. The speaker recognition techniques may include Gaussian mixture speaker models, frequency estimation, hidden Markov models, pattern matching algorithms, neural networks, matrix representation, Vector Quantization and decision trees, among others. If a contact is not determined to be within a shared environment, the method may continue back to 702 and continue sampling environmental noise.

If a contact is determined to be within a shared environment at 706, the method may continue to 708, where a controller of the device may deliver the bookmark in response to the determination that the contact is in within the environment. Delivery of the bookmark can include display of a message, alert, or delivery of media. Delivery of the bookmark may also include the playing of an audio message, vibration, or any combination of the above mentioned indicia. The method may then end at 710. In various examples, ending may include the continued sampling of audio from the environment.

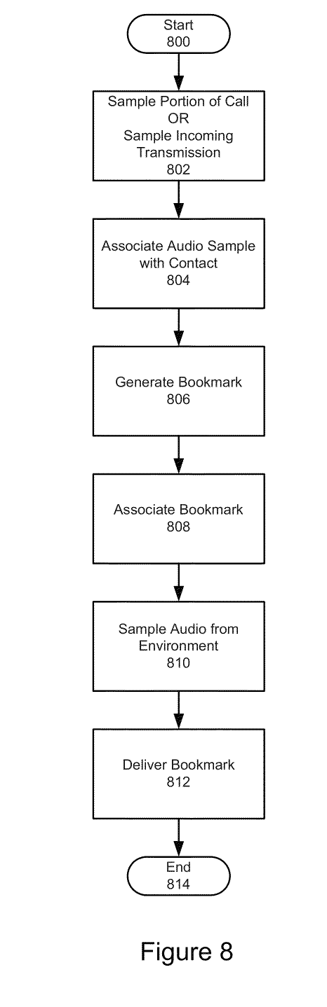

Referring to FIG. 8, another example flow diagram is illustrated in accordance with the present disclosure. The method may begin at 800 and progress to 802 where a mobile device may generate an audio sample of a voice received via a call. In one example, the audio sample may be generated by sampling a portion of the call, for example, the first five seconds. In another example, the audio sample may be generated by sampling the incoming transmission of the voice call. Sampling the incoming transmission may enable the mobile device to separate the voice of the contact from the voice of the user/owner.

After generation of the audio sample, the mobile device may associate the audio sample with an appropriate contact at 804. The appropriate contact is the contact participating in the call. After associating the audio sample with the contact, that contact may be associated with a bookmark intended to be delivered in response to a shared presence within an environment.

Consequently, at 806 a mobile device may generate a bookmark. Generation of a bookmark may include generation of message, selection of content from the web to be delivered, various alerts, or other data deliverable to a user. After generation of the bookmark at 806, the bookmark is associated with a contact or contacts. Associating the bookmark with a contact or contacts enables the mobile device to deliver the bookmark in response to a determination that the contact is within a shared environment.

After association of the bookmark with a contact, the mobile device, at 810, may begin sampling environmental noise for the presence of the contact. Sampling of background noise may include the use of a microphone, filters, and other components to isolate background noise from voices. In response to determining that a contact is within a shared environment, the mobile device may deliver the bookmark at 812.

The method may then end at 814. Ending in various embodiments, may include the generating of other audio samples from voices calls associates with contacts of the mobile devices, continued sampling of the environment for the presence of contacts having associated bookmarks, or alternatively, the generation of new bookmarks.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a wide variety of ways. This application is intended to cover any adaptations or variations of the embodiments discussed herein. Therefore, it is manifestly intended that embodiments be limited only by the claims and the equivalents thereof.

What is claimed is:

1. A method, comprising:
generating, by a mobile device, an audio sample of a voice received via a call;
associating, by the mobile device, the audio sample with a contact participating in the call, wherein the contact is included in a contact list of the mobile device; and
sampling, by the mobile device, audio from an environment to determine whether the contact is in the environment, wherein the determination is based, in part, on the audio sample of the voice.

2. The method of claim 1, further comprising:
associating, by the mobile device, a bookmark with the contact, wherein the bookmark is triggered if the contact is in the environment.

3. The method of claim 2, further comprising:
generating, by the mobile device, the bookmark.

4. The method of claim 2, further comprising:
delivering, by the mobile device, the bookmark in response to the determination that the contact is in the shared environment.

5. The method of claim 1, wherein generating the audio sample of the voice comprises sampling a predefined portion of the call.

6. The method of claim 1, wherein generating the audio sample of the voice comprises sampling an incoming transmission.

7. The method of claim 1, further comprising:
determining, by the mobile device, that the contact is in the environment based on the audio sample of the voice and a speaker recognition technique,

8. The method of claim 1, further comprising:
generating, by the mobile device, an audio sample of another voice received via another call; and
associating, by the mobile device, the audio sample of the another voice with another contact participating in the call, wherein the another contact is included in the contact list of the mobile device.

9. An apparatus, comprising:
an audio sampler to generate an audio sample of a voice call and to sample environmental noise; and
a controller coupled to the audio sampler, wherein the controller is to compare the sample of the voice call with environmental noise to determine whether a contact associated with the voice call is located in the environment.

10. The apparatus of claim 9, wherein the controller is further to associate a bookmark with the contact, and trigger the bookmark in response to a determination that the contact is located in the environment.

11. The apparatus of claim 10, wherein the bookmark is a message generated by a user of the apparatus.

12. The apparatus of claim 10, wherein the bookmark includes media content.

13. The apparatus of claim 10, wherein the controller is to associate the sample of the voice call with the contact.

14. The apparatus of claim 10, wherein the controller is to determine whether the contact is located in the environment based, in part, on a speaker recognition technique.

15. The apparatus of claim 10, wherein the audio sampler is to generate the audio sample of a voice call for each contact within a contact list of the apparatus.
